(19) United States
(12) Patent Application Publication
(10) Pub. No.: US 2019/0012555 A1
(43) Pub. Date: Jan. 10, 2019

(54) IMAGE SENSOR INCLUDING LIGHT-SHIELDING MEMBER FOR BLOCKING INTERFERENCE BETWEEN PLURALITY OF LIGHT-RECEIVING SENSORS AND ELECTRONIC DEVICE INCLUDING THE SAME

(71) Applicant: SAMSUNG ELECTRONICS CO., LTD., Suwon-si (KR)

(72) Inventors: Jae Cheol BAE, Suwon-si (KR); Hyun Jea KIM, Suwon-si (KR); Shi Hong PARK, Suwon-si (KR)

(21) Appl. No.: 16/031,091

(22) Filed: Jul. 10, 2018

(30) Foreign Application Priority Data
Jul. 10, 2017 (KR) 10-2017-0087287

(51) Int. Cl. G06K 9/20; G06K 9/00; G09G 5/10

(52) U.S. Cl. CPC G06K 9/209; G06K 9/0004; G09G 3/3225; G06K 9/2027; G09G 5/10

(57) ABSTRACT

An electronic device according to various embodiments includes a display panel and an image sensor disposed below at least a partial area of the display panel. The image sensor includes a lens unit including a first lens for modifying a path of a portion of reflected light and a second lens for modifying a path of another portion of the reflected light, an optical sensor including a first light-receiving sensor and a second light-receiving sensor, and at least one light-shielding member disposed between the first light-receiving sensor and the second light-receiving sensor.

### CROSS-REFERENCE TO RELATED APPLICATION

This application is based on and claims priority under 35 U.S.C. § 119 to Korean Patent Application No. 10-2017-0087287, filed on Jul. 10, 2017, in the Korean Intellectual Property Office, the disclosure of which is incorporated by reference herein its entirety.

### BACKGROUND

### 1. Field

The present disclosure relates to an electronic device including an image sensor for recognizing an external object.

### 2. Description of Related Art

Mobile electronic devices, such as smartphones, tablet PCs, wearable devices, and the like, have been widely used. These electronic devices may perform various functions, such as a telephone call function, a wireless communication function, a video reproduction function, a function of searching the Web, and the like. In recent years, security-related functions, such as payment for goods, banking, and the like, which use the electronic devices have been widely used, and the use of biometrics technology (e.g., fingerprint recognition, iris recognition, and the like) has been increased correspondingly.

In the related art, a fingerprint sensor included in an electronic device is formed in a lower bezel area of the electronic device. In this case, it may be difficult to extend a display.

Furthermore, the fingerprint sensor in the related art operates in a capacitive type. In this case, a fingerprint may be resolved due to a capacitance difference between ridges and valleys of the fingerprint. In general, a gap between ridges and valleys of a person's fingerprint is about 100 μm, and a separation distance of about 200 μm between a fingerprint sensor and a fingerprint has to be ensured to resolve a fingerprint of a 250 ppi level in a capacitive type. In a fingerprint recognition process, signal interference may occur in exponential proportion to the separation distance. The signal interference may cause blur of a fingerprint image and a decrease in fingerprint recognition ratio.

### SUMMARY

In accordance with an aspect of the present disclosure, an electronic device includes a display panel including at least one pixel area in which a plurality of pixels for radiating light outside the electronic device are arranged and at least one light-transmitting area through which at least a portion of light reflected by an object outside passes and an image sensor disposed below at least a partial area of the display panel. The image sensor includes a lens unit comprising a first lens configured to modify a path of a portion of the reflected light and a second lens configured to modify a path of another portion of the reflected light, an optical sensor including a first light-receiving sensor configured to receive the portion of the reflected light having passed through the lens unit and a second light-receiving sensor configured to receive the other portion of the reflected light, and at least one light-shielding member comprising a light-shielding material disposed between the first light-receiving sensor and the second light-receiving sensor, wherein the light-shielding member is configured to block interference between the portion of the reflected light obtained by the first light-receiving sensor and the other portion of the reflected light obtained by the second light-receiving sensor.

An electronic device according to various embodiments of the present disclosure may implement a thin fingerprint sensor mounted on a rear surface of a display panel.

An electronic device according to various embodiments of the present disclosure may use a portion of a display other than a bezel area as a fingerprint recognition area.

An electronic device according to various embodiments of the present disclosure may increase fingerprint detection efficiency using a micro lens layer and a single light-shielding layer.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a diagram illustrating various aspects of an electronic device for recognizing an external object using a partial area of a display according to various embodiments;

FIG. 2 is a diagram illustrating an internal configuration and a cross-section of a fingerprint sensor according to various embodiments;

FIG. 3A is a diagram illustrating a process in which a fingerprint sensor collects reflected light according to various embodiments;

FIG. 3B is a flowchart illustrating a process of recognizing a fingerprint according to various embodiments;

FIGS. 4A and 4B diagrams illustrating an arrangement of optical sensors according to various embodiments;

FIG. 5 is a diagram illustrating a configuration of a display panel according to various embodiments;

FIG. 6 is a diagram illustrating an arrangement relationship between a display panel and a fingerprint sensor and a sensing information graph according to various embodiments;

FIGS. 7A and 7B are graphs illustrating refractive-index characteristics and spectral characteristics according to various embodiments;

FIG. 8 is a diagram illustrating selective transmission of light through a filter according to various embodiments; and

FIG. 9 is a block diagram illustrating an electronic device in a network environment according to various embodiments.

### DETAILED DESCRIPTION

Below, various example embodiments of the present disclosure may be described with reference to accompanying drawings. Accordingly, those of ordinary skill in the art will recognize that modifications, equivalents, and/or alternatives of the various example embodiments described herein can be variously made without departing from the scope and spirit of the present disclosure. With regard to description of drawings, similar components may be marked by similar reference numerals.

In the disclosure, the expressions “have”, “may have”, “include” and “comprise”, or “may include” and “may comprise” used herein indicate existence of corresponding features (e.g., numeric values, functions, operations, or components such as parts) but do not exclude presence of additional features.

Also, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used herein may refer to various components of various embodiments of the present disclosure, but do not limit the elements. For example, “a first user device” and “a second user device” indicate different user devices regardless of the order or priority. For example, without departing the scope of the present disclosure, a first complement may be referred to as a second component, and similarly, a second complement may be referred to as a first complement.

It will be understood that when a component (e.g., a first component) is referred to as being “(operatively or communicatively) coupled with/to” or “connected to” another component (e.g., a second component), it can be directly coupled with/to or connected to the other component or an intervening component (e.g., a third complement) may be present. On the other hand, when a component (e.g., a first component) is referred to as being “directly coupled with/to” or “directly connected to” another component (e.g., a second component), it should be understood that there is no intervening component (e.g., a third component).

According to the situation, the expression “configured to” used herein may be used interchangeably with, for example, the expression “suitable for”, “having the capacity to”, “designed to”, “adapted to”, “made to”, or “capable of”. The term “configured to” does not mean only “specifically designed to” in hardware. Instead, the expression “a device configured to” may refer to a situation in which the device is “capable of” operating together with another device or other components. For example, a “processor configured to (or set to) perform A, B, and C” may refer, for example, and without limitation, to a dedicated processor (e.g., an embedded processor) for performing a corresponding operation, a generic-purpose processor (e.g., a central processing unit (CPU) or an application processor) which may perform corresponding operations by executing one or more software programs which are stored in a memory device, or the like.

Terms used in the disclosure are used to describe specific embodiments of the present disclosure and are not intended to limit the scope of the present disclosure. The terms of a singular form may include plural forms unless otherwise specified. All the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein. In some cases, even though terms are terms which are defined in the disclosure, they may not be interpreted to exclude embodiments of the present disclosure.

An electronic device according to various embodiments of the present disclosure may include at least one of a smartphone, a tablet personal computer (PC), a mobile phone, a video telephone, an electronic book reader, a desktop PC, a laptop PC, a netbook computer, a workstation, a server, personal digital assistant (PDA), a portable multimedia player (PMP), a Motion Picture Experts Group (MPEG-1 or MPEG-2) Audio Layer 3 (MP3) player, a mobile medical device, a camera, and/or a wearable device, or the like, but is not limited thereto. According to various embodiments, a wearable device may include at least one of an accessory type of device (e.g., a timepiece, a ring, a bracelet, an anklet, a necklace, glasses, a contact lens, or a head-mounted device (HMD)), a one-piece fabric or clothes type of device (e.g., electronic clothes), a body-attached type of device (e.g., a skin pad or a tattoo), and/or a bio-implantable type of device (e.g., implantable circuit), or the like, but is not limited thereto.

Hereinafter, an electronic device according to various embodiments will be described with reference to the accompanying drawings. The term “user” used herein may refer to a person who uses an electronic device or may refer to a device (e.g., an artificial intelligence electronic device) that uses the electronic device.

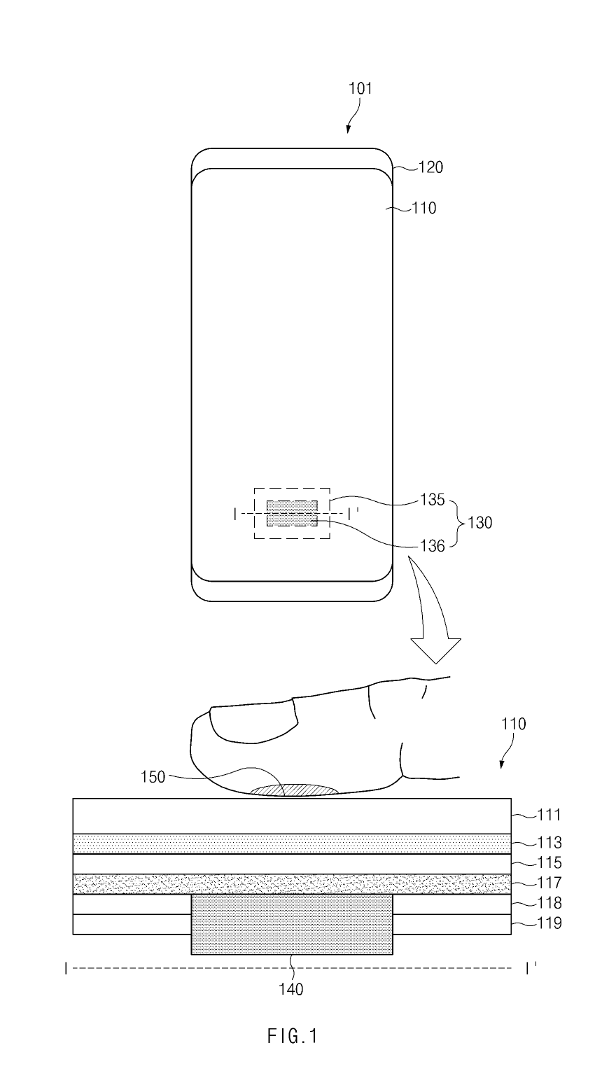

FIG. 1 is a diagram illustrating various components of an electronic device for recognizing an external object by using a partial area of a display according to various embodiments. The following description of FIG. 1, will be made with reference to an example in which the external object is a fingerprint. However, the present disclosure is not limited thereto.

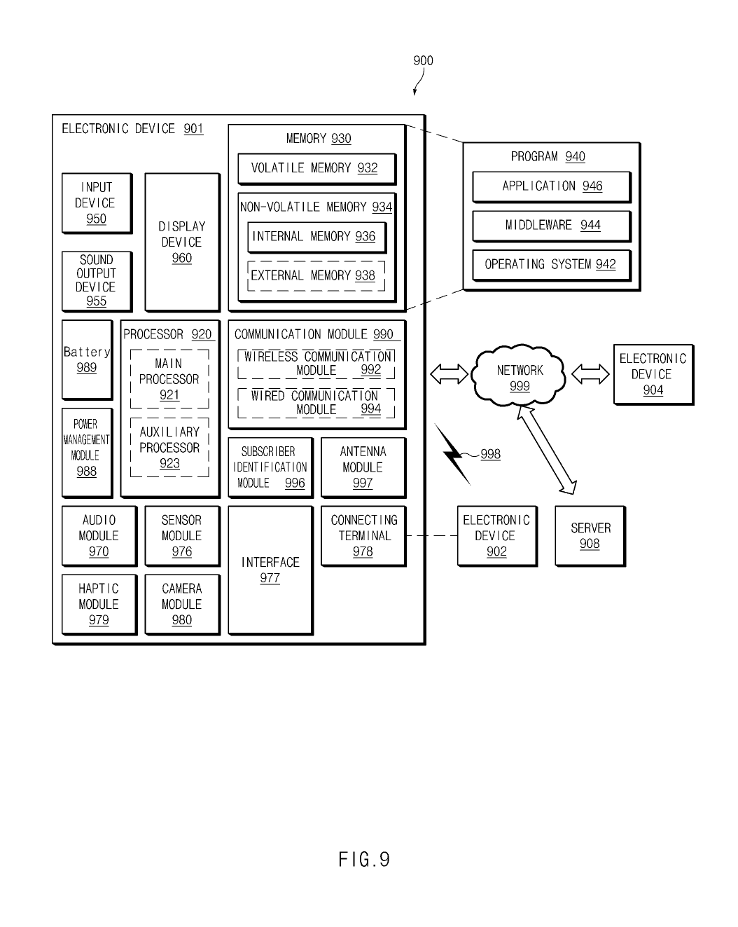

Referring to FIG. 1, an electronic device 101 (e.g., an electronic device 901 of FIG. 9) may include a display (or a display module) 110 (e.g., a display device 960 of FIG. 9) and a main body (or a housing) 120.

The display 110 may include, for example, and without limitation, a liquid crystal display (LCD), a light-emitting diode (LED) display, an organic LED (OLED) display, a microelectromechanical systems (MEMS) display, and/or an electronic paper display, or the like. The display 110 may display, for example, various types of contents (e.g., text, images, videos, icons, symbols, and/or the like) to the user. The display 110 may include a touch screen and may receive, for example, a touch, gesture, proximity, or hovering input using an electronic pen or a part of the user's body. The display 110 may include a glass cover exposed to the outside and various layers inward of the glass cover.

According to various embodiments, the display 110 may be disposed to occupy all (bezel-less) or most of a front surface of the electronic device 101 (a surface where the contents are output through the display 110). For example, the display 110 may extend to side surfaces (e.g., top/bottom/left/right side surfaces) of the electronic device 101.

According to various embodiments, the display 110 may include a fingerprint recognition area 130 therein. The fingerprint recognition area 130 may be an area for collecting fingerprint information based on which user authentication is performed, using light reflected by a fingerprint 150 of the user when the user locates the finger on the fingerprint recognition area 130. For example, the electronic device 101 may execute a payment or security related function using the recognized fingerprint information.

According to various embodiments, the fingerprint recognition area 130 may be a location where a thumb is easily situated when the user holds the electronic device 101 with a hand in a vertical mode (or a portrait mode).

According to various embodiments, the fingerprint recognition area 130 may output contents, such as text, images, or the like, similarly to the rest of the display 110 when not performing the fingerprint recognition function. When the fingerprint recognition function is executed, the fingerprint recognition area 130 may be displayed in a different color than the rest of the display 110, or only the corresponding portion may be changed into an emissive state (a state in which light is emitted from pixels in the display 110).

According to various embodiments, the fingerprint recognition area 130 may include a light-emitting area 135 and a sensing area 136. According to an embodiment, the light-emitting area 135 may be the same as, or larger than, the sensing area 136. According to another embodiment, the light-emitting area 135 may be smaller than the sensing area 136.

The light-emitting area 135 may be an area for generating light in a process of recognizing a fingerprint. The light-emitting area 135 may be an area for emitting light from the pixels in the display 110 to the outside. The light emitted from the light-emitting area 135 may be reflected by the fingerprint 150 of the user.

The sensing area 136 may collect the light reflected by the fingerprint 150 of the user (hereinafter, referred to as reflected light). The sensing area 136 may convert the reflected light into an electrical signal to generate fingerprint information. The fingerprint information may be transmitted to a processor or a controller in the electronic device 101 and may be used to execute a payment or security related function.

According to various embodiments, referring to a sectional view taken along line IT, the display 110 may have a structure in which a transparent layer (or a window panel) 111, an adhesive layer 113, a polarization layer 115, a display panel 117, a protection layer 118, and a heat dissipation layer 119 are sequentially stacked one above another. FIG. 1 is merely illustrative, and the present disclosure is not limited thereto. The display 110 may not include some of the layers or may further include some layers. For example, the display 110 may further include a touch panel (not illustrated). In another example, the display 110 may further include a lighting layer (not illustrated) disposed above the display panel 117 to radiate light to the outside. The lighting layer may output, to the outside, light (e.g., light in a green wavelength band or a blue wavelength band) that is advantageous for recognizing the fingerprint 150 of the user.

The transparent layer 111 may be disposed at the top of the display 110. The transparent layer 111 may protect the elements in the display 110. Light emitted from the display panel 117 may be output to the outside through the transparent layer 111. In an embodiment, the transparent layer 111 may introduce light incident from the outside into the display 110.

The adhesive layer 113 may stick the transparent layer 111 to the polarization layer 115. For example, the adhesive layer 113 may be implemented with an OCA film (a double-sided adhesive tape).

The polarization layer 115 may polarize light incident from the outside and may pass light in which an electric field oscillates along a specified linear path. The polarization layer 115 may block light not in agreement with the specified linear path.

The display panel 117 may be a layer that emits light in response to an electrical signal. The display panel 117 may have a form in which light-emitting elements (e.g., organic electro luminescence (EL)) are deposited on a thin film transistor (TFT) substrate. The TFT substrate may include TFT devices for driving respective pixels in an active area, metal interconnection wiring, an insulation film, and the like. The organic EL may generate light when holes and electrons are injected from a cathode and an anode.

The protection layer 118 may be a film layer for protecting the display panel 117. The protection layer 118 may prevent and/or reduce the display panel 117 from colliding with elements inside the electronic device 101. The heat dissipation layer 119 may block heat radiating from the display panel 117.

According to various embodiments, a fingerprint sensor 140 (or an image sensor) (e.g., a sensor module 976 of FIG. 9) may be mounted in the fingerprint recognition area 130. A surface (a sensing surface) of the fingerprint sensor 140 that collects light may be disposed to face the display panel 117. The fingerprint sensor 140 may be mounted in a portion of a rear surface of the display 110 where some layers are removed. For example, the fingerprint sensor 140 may be disposed in an area where the protection layer 118 and the heat dissipation layer 119 below the display panel 117 are removed. The protection layer 118 and the heat dissipation layer 119 may have a hole or opening formed in an area thereof that makes contact with the fingerprint sensor 140.

While FIG. 1 illustrates that a portion of the protection layer 118 and a portion of the heat dissipation layer 119 are removed and the fingerprint sensor 140 is mounted in the empty area, the present disclosure is not limited thereto. For example, the fingerprint sensor 140 may also be mounted in a state in which the protection layer 118 is removed and the heat dissipation layer 119 is maintained. In another example, some layers below the display panel 117 may have a small thickness, and the fingerprint sensor 140 may be included in the layers.

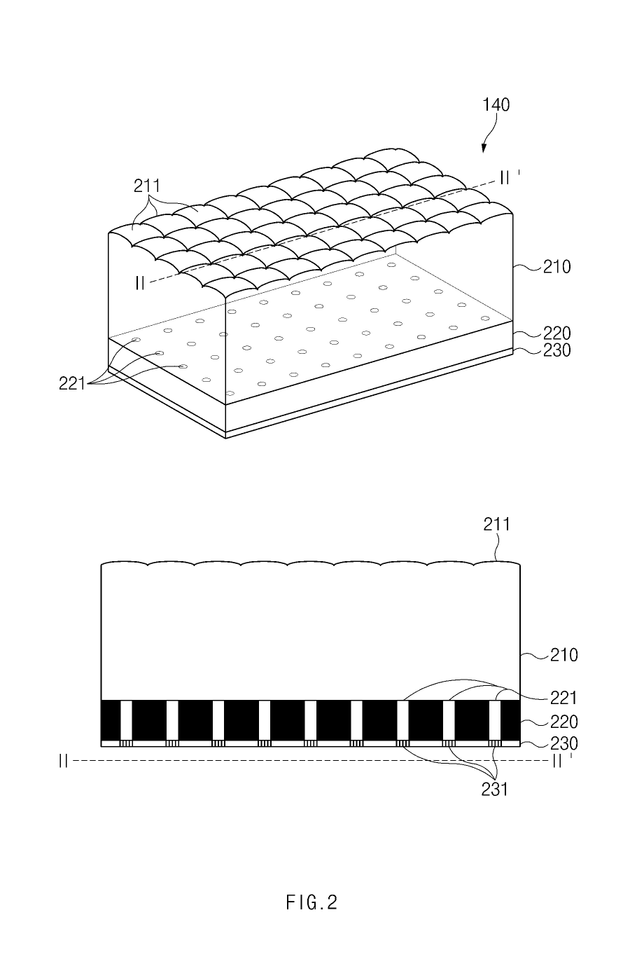

According to various embodiments, the fingerprint sensor 140 may include, for example, and without limitation, a micro lens layer, a light-shielding layer, an optical sensor layer, and the like. The fingerprint sensor 140 may collect recognition information about the fingerprint 150 using light output from the display panel 117 and then reflected by the fingerprint 150 of the user. Additional disclosure about a structure of the fingerprint sensor 140 will be provided in greater detail below with reference to FIG. 2.

The display 110 may be mounted on the main body 120. The main body 120 may have various elements (e.g., a processor, a communication circuit, a battery, a PCB, or the like) therein for driving the electronic device 101.

FIG. 2 is a diagram illustrating an internal configuration and a cross-section of a fingerprint sensor according to various embodiments.

Referring to FIG. 2, the fingerprint sensor 140 may include a micro lens layer 210, a light-shielding layer (or a light-shielding member) 220, and an optical sensor layer (or an optical sensor) 230.

The micro lens layer 210 may have a plurality of lenses 211 arranged therein. The micro lens layer 210 may modify a path of reflected light introduced through the display panel 117. The plurality of lenses 211 may, for example, and without limitation, be circular lenses protruding toward the outside. In an embodiment, the plurality of lenses 211 may each be formed in a rectangular section. While FIG. 2 illustrates that the plurality of lenses 211 are implemented in a fly-eye form, the present disclosure is not limited thereto.

According to various embodiments, the micro lens layer 210 may have a thickness of a specified value or less. For example, and without limitation, the micro lens layer 210 may have a pitch of 100 μm or less to resolve a fingerprint of a 250 ppi level.

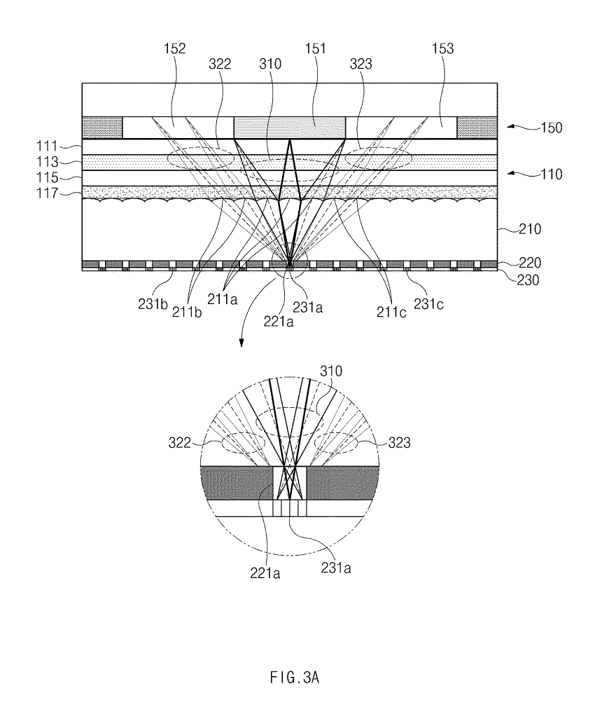

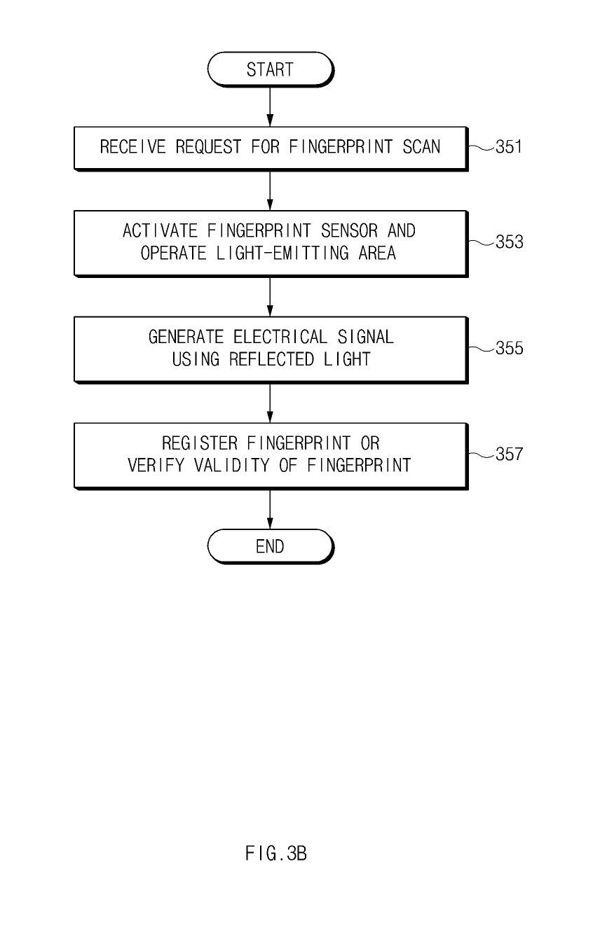

The light-shielding layer 220 may include a material (e.g., metal) that blocks light, and may include a plurality of holes 221 according to a specified pattern. The plurality of holes 221 may serve as a light path along which the reflected light is transmitted to the optical sensor layer 230. A portion of the reflected light refracted through the plurality of lenses 211 in the micro lens layer 210 may be transmitted to the optical sensor layer 230 through the plurality of holes 221, and another portion of the reflected light may be blocked by the rest of the light-shielding layer 220 other than the plurality of holes 221. The reflected light transmitted to the optical sensor layer 230 through the plurality of holes 221 may be effective light necessary for fingerprint recognition. The blocked reflected light may be noise (e.g., crosstalk or interference) unnecessary for fingerprint recognition. Additional disclosure about passing or blocking the reflected light by the light-shielding layer 220 will be provided in greater detail below with reference to FIG. 3A.

According to various embodiments, the light-shielding layer 220 may be implemented with a single layer or a plurality of layers. In the case where the light-shielding layer 220 is implemented with a single layer, it is unnecessary to form spacing between light-shielding layers and it is possible to prevent and/or reduce an increase in the entire thickness of the fingerprint sensor 140 due to the thickness of the light-shielding layer 220.

The optical sensor layer 230 may include a plurality of optical sensors (or light-receiving sensors) 231. The plurality of optical sensors 231 may, for example, and without limitation, be disposed in areas corresponding to the plurality of holes 221. The plurality of optical sensors 231 may convert the reflected light introduced through the plurality of holes 221 into an electrical signal.

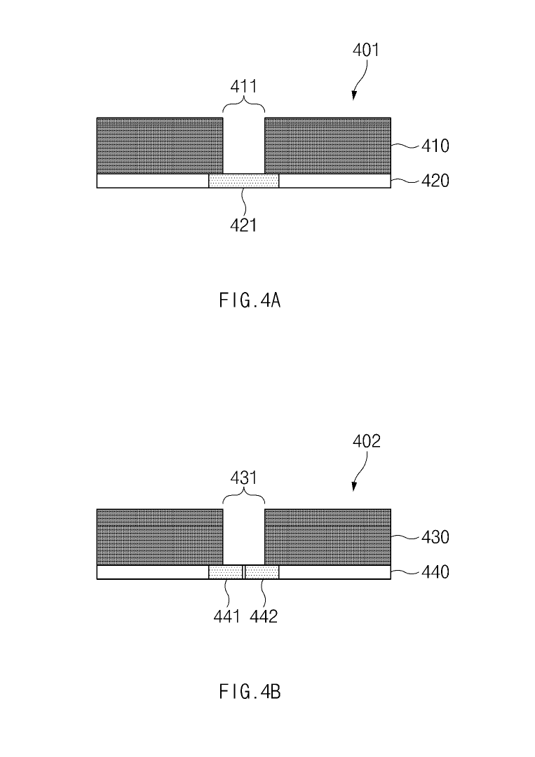

According to various embodiments, one or more optical sensors 231 may be disposed in an area corresponding to each of the holes 221. Additional disclosure about an arrangement of the plurality of optical sensors 231 will be provided in greater detail below with reference to FIG. 4.

FIG. 3A is a diagram illustrating a process in which a fingerprint sensor collects reflected light according to various embodiments. Although the following description of FIG. 3A will be focused on reflected light collected through a hole 221a and an optical sensor 231a vertically disposed below a ridge 151, the present disclosure is not limited thereto.

Referring to FIG. 3A, the user may bring the fingerprint 150 into close contact with a surface of the display 110. Light output through the display panel 117 in the display 110 may be output to the outside. The output light may be transformed into reflected light 310, 322, and 323 by a surface of the fingerprint 150. The reflected light 310, 322, and 323 may be reflected by the fingerprint 150 and may be introduced back into the display 110. The reflected light 310, 322, and 323 may pass through the transparent layer (or the window panel) 111, the adhesive layer 113, the polarization layer 115, and the display panel 117 and may be transmitted to the micro lens layer 210.

The fingerprint 150 may include the ridge 151 and valleys 152 and 153. The ridge 151 may be convex toward the outside, and the valleys 152 and 153 may be concave toward the inside. The ridge 151 and the valleys 152 and 153 may introduce the reflected light 310, 322, and 323 into the display 110.

The first reflected light 310 may be light reflected by the ridge 151 and may be an effective component for fingerprint recognition when received by the optical sensor 231a vertically disposed below the ridge 151.

The first reflected light 310 may be refracted by a first lens unit 211a disposed adjacent to an area corresponding to the hole 221a (e.g., an area vertically located above the hole 221a). The refracted first reflected light 310 may be transmitted to the optical sensor 231a through the hole 221a.

The second reflected light 322 may be light reflected by the valley 152 and may act as an unnecessary noise component (e.g., crosstalk) when received by the optical sensor 231a. The second reflected light 322 may be blocked by the light-shielding layer 220 and may not be transmitted to the optical sensor 231a vertically disposed below the ridge 151. The second reflected light 322 may be processed as effective fingerprint data when transmitted to an optical sensor 231b vertically disposed below the valley 152.

The third reflected light 323 may be light reflected by the valley 153 and may act as an unnecessary noise component (e.g., crosstalk) when received by the optical sensor 231a. The third reflected light 323 may be blocked by the light-shielding layer 220 and may not be transmitted to the optical sensor 231a vertically disposed below the ridge 151. The third reflected light 323 may be processed as effective fingerprint data when transmitted to an optical sensor 231c vertically disposed below the valley 153. The second reflected light 322 and the third reflected light 323 may be refracted by a second lens unit 211b or 211c, respectively, relatively far away from the area corresponding to the hole 221a (e.g., the area vertically located above the hole 221a). The second reflected light 322 and the third reflected light 323 that have been refracted may be blocked by the light-shielding layer 220 around the hole 221a and may not be transmitted to the optical sensor 231a.

According to various embodiments, each of the plurality of holes 221 may collect light refracted by a lens disposed within a specified range above the hole 221. For example, the hole 221a may collect light refracted by nine lenses (including the lens unit 211a) disposed above the hole 221a. In another example, the hole 221a may collect light refracted by one lens disposed above the hole 221a (a lens disposed in the middle of the lens unit 211a).

FIG. 3B is a flowchart illustrating a process of recognizing a fingerprint according to various embodiments.

Referring to FIG. 3B, in operation 351, the controller (or the processor) (e.g., a processor 920 of FIG. 9) in the electronic device 101 may receive a request for fingerprint scan. The controller may start a fingerprint recognition process, for example, in the case where a user input for fingerprint scan occurs (e.g., registration of a new fingerprint) or a fingerprint-related app makes a request (e.g., a request of a payment app).

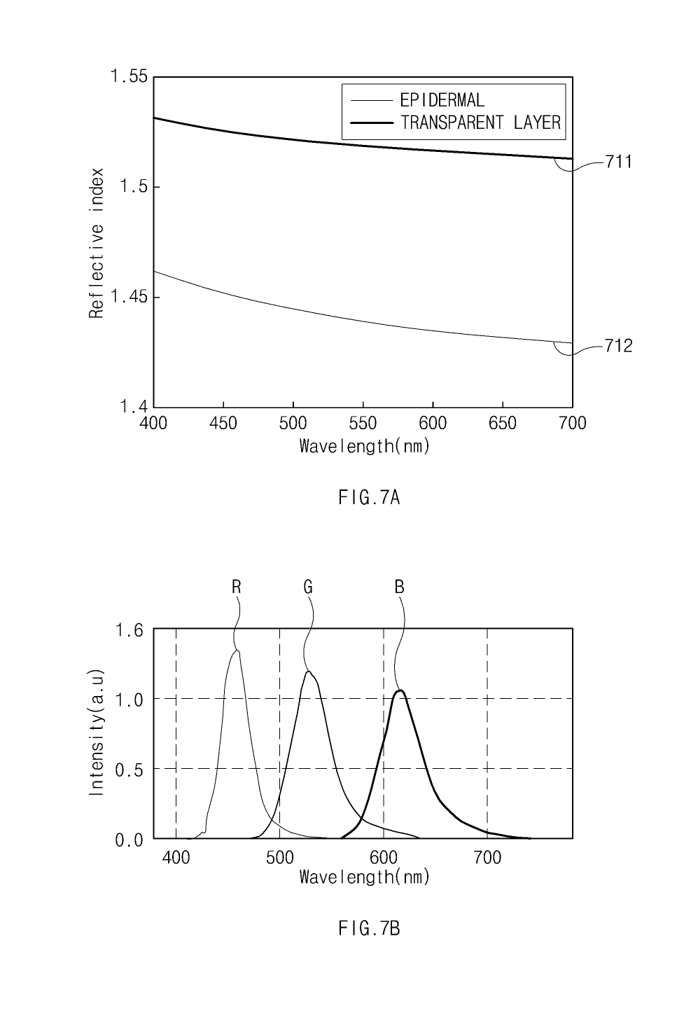

In operation 353, the controller may activate the fingerprint sensor 140 and may operate pixels included in a light-emitting area (e.g., the light-emitting area 135 of FIG. 1) to generate light. According to an embodiment, the controller may operate only some of the pixels included in the light-emitting area 135 (refer to FIG. 7).

In operation 355, each optical sensor included in the optical sensor layer 230 may generate an electrical signal using light reflected by a fingerprint. According to an embodiment, the optical sensor may output an electrical signal using the reflected light introduced through the corresponding hole included in the light-shielding layer 220.

In operation 357, the controller may register the user's fingerprint or may verify validity of the recognized fingerprint, based on the electrical signal converted by each optical sensor. For example, the controller may compare the electrical signal generated by each optical sensor with a reference value set in advance to determine whether a fingerprint section located above the optical sensor is a ridge or a valley.

FIGS. 4A and 4B are diagrams illustrating an arrangement of optical sensors according to various embodiments. FIGS. 4A and 4B are merely illustrative, and the present disclosure is not limited thereto.

Referring to FIG. 4A, a fingerprint sensor 401 (e.g., the fingerprint sensor 140) may include a micro lens layer (not illustrated), a light-shielding layer 410, and an optical sensor layer 420.

The micro lens layer (e.g., the micro lens layer 210 of FIG. 2) may modify a path of light reflected by a fingerprint. The light-shielding layer 410 (e.g., the light-shielding layer 220 of FIG. 2) may include a hole 411 (e.g., the hole 221 of FIG. 2) that guides a portion of the reflected light necessary for fingerprint recognition toward the optical sensor layer 420 (e.g., the optical sensor layer 230 of FIG. 2).

The optical sensor layer 420 may include a light-receiving pixel (or a light-receiving sensor) 421 in an area corresponding to the hole 411 of the light-shielding layer 410. The light-receiving pixel 421 may, for example, and without limitation, be disposed such that the center of the light-receiving pixel 421 is aligned with the center of the hole 411. The light-receiving pixel 421 may change received light into an electrical signal.

Referring to FIG. 4B, a fingerprint sensor 402 may include a micro lens layer (not illustrated) (e.g., the micro lens layer 210 of FIG. 2), a light-shielding layer 430 (e.g., the light-shielding layer 220 of FIG. 2), and an optical sensor layer 440 (e.g., the optical sensor layer 230 of FIG. 2).

Unlike the optical sensor layer 420 of the fingerprint sensor 401, the optical sensor layer 440 of the fingerprint sensor 402 may, for example, and without limitation, include a plurality of light-receiving pixels 441 and 442 in an area corresponding to a hole 431 of the light-shielding layer 430 (e.g., the hole 221 of FIG. 2). While FIG. 4B illustrates that the two light-receiving pixels 441 and 442 are disposed in the area corresponding to the hole 431, the present disclosure is not limited thereto.

The plurality of light-receiving pixels 441 and 442 may change received light into an electrical signal. The signals collected through the plurality of light-receiving pixels 441 and 442 may be used for fingerprint recognition according to a specified method. For example, the controller (or the processor) in the electronic device 101 may recognize a fingerprint by averaging the signals collected by the light-receiving pixels. In another example, the controller (or the processor) in the electronic device 101 may recognize a fingerprint by increasing a weighting value for a light-receiving pixel corresponding to the center of the hole 431 and decreasing a weighting value for a nearby light-receiving pixel.

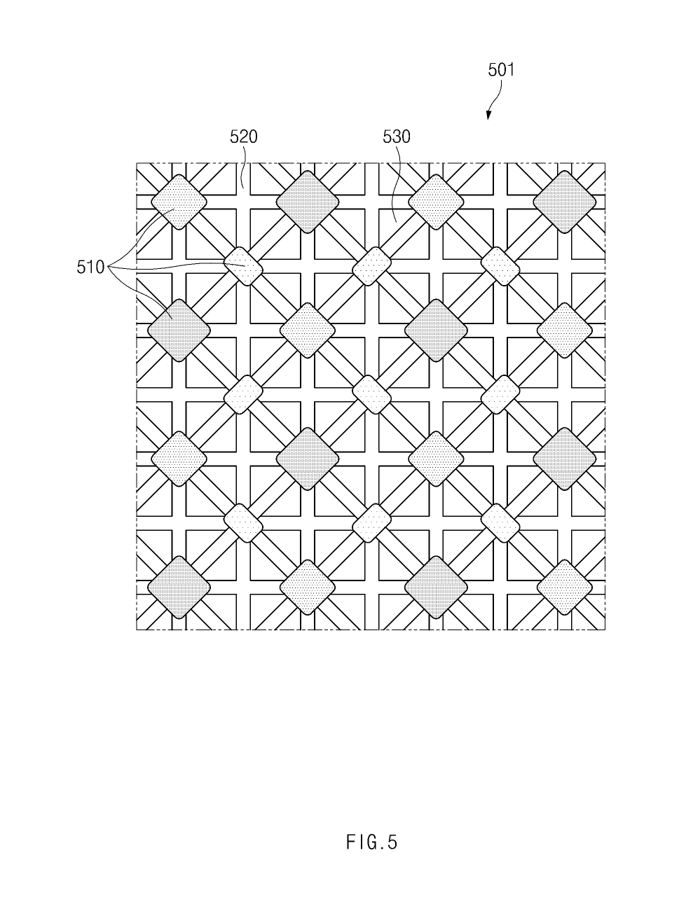

FIG. 5 is a diagram illustrating a configuration of a display panel according to various embodiments.

Referring to FIG. 5, a display panel 501 may include light-emitting pixels (e.g., RGB pixels) 510 and a metal mesh 520.

The light-emitting pixels (e.g., the RGB pixels) 510 may emit light for outputting contents. Furthermore, the light emitted from the light-emitting pixels (e.g., the RGB pixels) 510 may be used for fingerprint recognition. Areas occupied by the light-emitting pixels (e.g., the RGB pixels) 510 may be non-light-transmitting areas that prevent and/or reduce light reflected by an external object from being transmitted to an optical sensor layer.

The metal mesh 520 may fix the light-emitting pixels (e.g., the RGB pixels) 510 and may transfer an electrical signal necessary for an operation of the light-emitting pixels (e.g., the RGB pixels) 510. The metal mesh 520 may be a non-light-transmitting area that prevents and/or reduces light reflected by the external object from being transmitted to the optical sensor layer.

Light-transmitting areas 530 may be included in the metal mesh 520. Light reflected by a fingerprint may pass through the light-transmitting areas 530 in the metal mesh 520 and may be introduced into a fingerprint sensor disposed on a rear surface of the display panel 501. The light having passed through the light-transmitting areas 530 may be used for fingerprint recognition.

A portion of the reflected light introduced from the external object may be blocked by the display panel 501, and another portion of the reflected light may pass through the display panel 501. In this case, the amount of light transmitted to the optical sensor layer may be decreased, which may cause a reduction in the amount of light necessary for fingerprint recognition. In the case where the fingerprint sensor disposed below the display panel 501 includes a micro lens layer and a light-shielding layer, it is possible to concentrate an amount of light effective for fingerprint recognition on a light-receiving sensor and to block a nearby crosstalk component, thereby increasing efficiency of the fingerprint recognition.

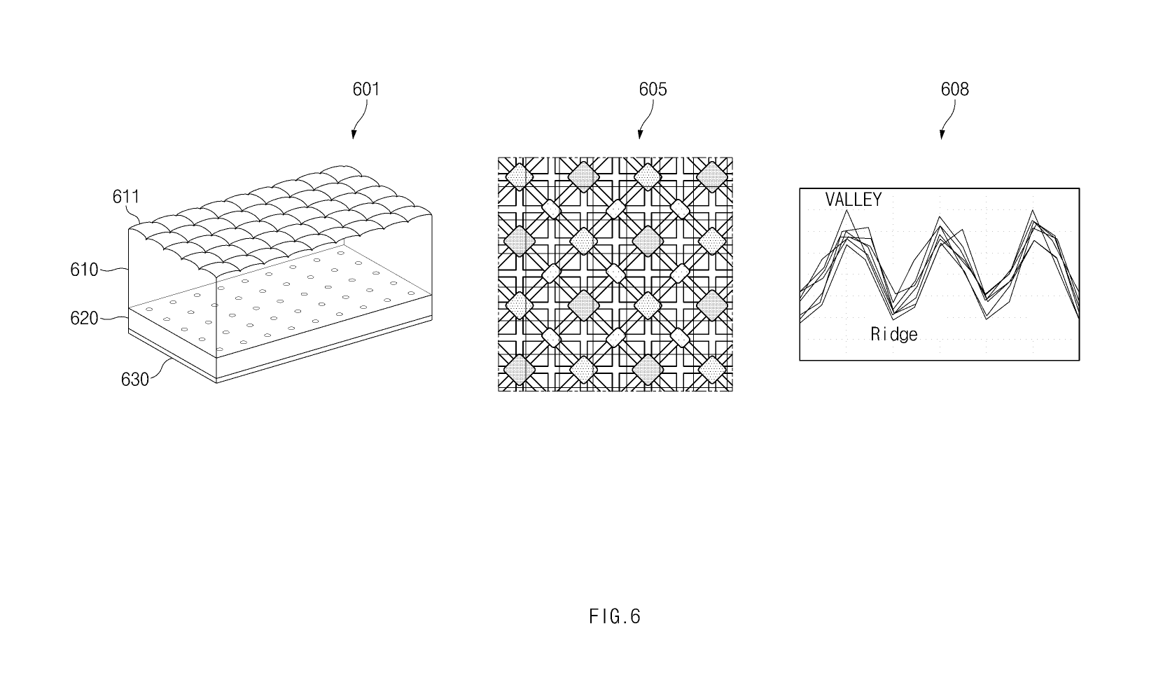

FIG. 6 is a diagram illustrating an arrangement relationship between a display panel and a fingerprint sensor and a sensing information graph according to various embodiments.

Referring to FIG. 6, a fingerprint sensor 601 may include a micro lens layer 610 including a plurality of lenses 611 arranged therein, a light-shielding layer 620, and an optical sensor layer 630. The micro lens layer 610 may modify a path of reflected light introduced through a display panel 605. The light-shielding layer 620 may pass a portion of the reflected light and may block another portion of the reflected light. The optical sensor layer 630 may generate an electrical signal using collected light.

The display panel 605 may be disposed above the fingerprint sensor 601. The display panel 605 may include a non-light-transmitting area and a light-transmitting area. For example, the non-light-transmitting area may include light-emitting pixels and a metal mesh. The light-transmitting area may include through-areas in the metal mesh.

According to various embodiments, the micro lens layer 610 and the pixels of the display panel 605 may be arranged according to a specified pattern. For example, a specified number or a specified ratio of light-emitting pixels may be disposed in a rectangular area where each lens included in the micro lens layer 610 is disposed.

The micro lens layer 610 may increase efficiency in receiving light having passed through the display panel 605, thereby reducing the height of the light-shielding layer 620. Accordingly, a thin fingerprint sensor may be implemented. In addition, a variation in a graph 608 of fingerprint recognition information collected through a light-receiving sensor may be reduced. As a result, a contrast to noise ratio (CNR) of a signal may be increased, and a false rejection ratio of fingerprint recognition may be decreased.

FIGS. 7A and 7B are graphs illustrating refractive-index characteristics and spectral characteristics according to various embodiments. FIG. 7A illustrates a relationship between a refractive index and a wavelength. FIG. 7B illustrates spectral characteristics of R/G/B pixels of an OLED display.

Referring to FIGS. 7A and 7B, a refractive index may be inversely proportional to a wavelength of light on the epidermis of a user's skin and a transparent layer.

A controller (or a processor) (not illustrated) that controls a fingerprint sensor may calculate (determine) a difference between an amount of light 711 reflected by the epidermis (ridges and valleys) of a fingerprint after emitted from a partial area of the display and an amount of light 712 reflected by the transparent layer after emitted from a partial area of the display. Based on the difference, the controller may resolve a fingerprint image using a contrast difference.

According to various embodiments, the controller (or the processor) (not illustrated) that controls the fingerprint sensor may use light in a specified wavelength band. For example, in the case of the OLED display, the controller may selectively use blue and green pixels and maintain red pixels in a turned-off state to increase contrast of the ridges and valleys of the fingerprint.

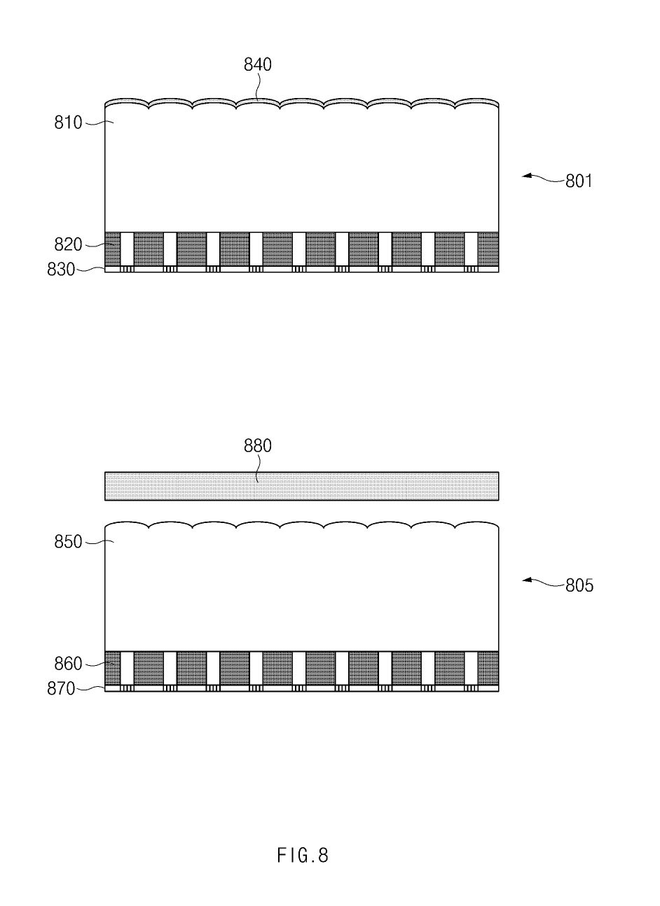

FIG. 8 is a diagram illustrating selective transmission of light through a filter according to various embodiments.

Referring to FIG. 8, a fingerprint sensor 801 (e.g., the fingerprint sensor 140) may include a micro lens layer 810 (e.g., the micro lens layer 210 of FIG. 2), a light-shielding layer 820 (e.g., the light-shielding layer 220 of FIG. 2), an optical sensor layer 830 (e.g., the optical sensor layer 230 of FIG. 2), and an optical filter 840.

The optical filter 840 may be disposed on an upper surface of the micro lens layer 810. The optical filter 840 may, for example, have a form (e.g., a fly-eye form) that corresponds to the upper surface of the micro lens layer 810. The optical filter 840 may, for example, and without limitation, be implemented in a multi-coating form on the upper surface of the micro lens layer 810.

The filter 840 may pass a portion of light and block another portion of the light depending on a wavelength. Accordingly, it is possible to pass light with a wavelength facilitating fingerprint recognition and to prevent and/or reduce light with other wavelengths from reaching the optical sensor layer 830. For example, the filter 840 may pass reflected light in green and blue wavelength bands and may block reflected light in a red wavelength band. Accordingly, the contrast of ridges and valleys of a fingerprint may be increased.

A fingerprint sensor 805 may include a micro lens layer 850 (e.g., the micro lens layer 210 of FIG. 2), a light-shielding layer 860 (e.g., the light-shielding layer 220 of FIG. 2), and an optical sensor layer 870 (e.g., the optical sensor layer 230 of FIG. 2). An optical filter layer 880 may be disposed above the fingerprint sensor 805 (between a display panel (not illustrated) and the fingerprint sensor 805). The optical filter layer 880 may pass a portion of light and block another portion of the light depending on a wavelength. The optical filter layer 880 may pass reflected light in green and blue wavelength bands and may block reflected light in a red wavelength band. Accordingly, the contrast of ridges and valleys of a fingerprint may be increased.

FIG. 9 illustrates a block diagram of an electronic device 901 in a network environment 900, according to various embodiments. An electronic device according to various embodiments of this disclosure may include various forms of devices. For example, the electronic device may include at least one of, for example, portable communication devices (e.g., smartphones), computer devices (e.g., personal digital assistants (PDAs), tablet personal computers (PCs), laptop PCs, desktop PCs, workstations, or servers), portable multimedia devices (e.g., electronic book readers or Motion Picture Experts Group (MPEG-1 or MPEG-2) Audio Layer 3 (MP3) players), portable medical devices (e.g., heartbeat measuring devices, blood glucose monitoring devices, blood pressure measuring devices, and body temperature measuring devices), cameras, and/or wearable devices, or the like, but are not limited thereto. The wearable device may include at least one of an accessory type (e.g., watches, rings, bracelets, anklets, necklaces, glasses, contact lens, or head-mounted-devices (HMDs)), a fabric or garment-integrated type (e.g., an electronic apparel), a body-attached type (e.g., a skin pad or tattoos), and/or a bio-implantable type (e.g., an implantable circuit), or the like, but is not limited thereto. According to various embodiments, the electronic device may include at least one of, for example, televisions (TVs), digital versatile disk (DVD) players, audios, audio accessory devices (e.g., speakers, headphones, or headsets), refrigerators, air conditioners, cleaners, ovens, microwave ovens, washing machines, air cleaners, set-top boxes, home automation control panels, security control panels, game consoles, electronic dictionaries, electronic keys, camcorders, and/or electronic picture frames, or the like, but are not limited thereto.

In another embodiment, the electronic device may include at least one of navigation devices, satellite navigation system (e.g., Global Navigation Satellite System (GNSS)), event data recorders (EDRs) (e.g., black box for a car, a ship, or a plane), vehicle infotainment devices (e.g., head-up display for vehicle), industrial or home robots, drones, automatic teller's machines (ATMs), points of sales (POSs), measuring instruments (e.g., water meters, electricity meters, or gas meters), and/or internet of things (e.g., light bulbs, sprinkler devices, fire alarms, thermostats, or street lamps), or the like, but are not limited thereto. The electronic device according to an embodiment of this disclosure may not be limited to the above-described devices, and may provide functions of a plurality of devices like smartphones which has measurement function of personal biometric information (e.g., heart rate or blood glucose). In this disclosure, the term “user” may refer to a person who uses an electronic device or may refer to a device (e.g., an artificial intelligence electronic device) that uses the electronic device.

Referring to FIG. 9, under the network environment 900, the electronic device 901 (e.g., the electronic device 101) may communicate with an electronic device 902 through local wireless communication 998 or may communication with an electronic device 904 or a server 908 through a network 999. According to an embodiment, the electronic device 901 may communicate with the electronic device 904 through the server 908.

According to an embodiment, the electronic device 901 may include a processor (e.g., including processing circuitry) 920, a memory 930, an input device 950 (e.g., including input circuitry, such as, for example, and without limitation, a micro-phone or a mouse), a sound output device (e.g., including sound output circuitry) 955, a display device 960, an audio module (e.g., including audio circuitry) 970, a sensor module 976, an interface (e.g., including interface circuitry) 977, a haptic module (e.g., including haptic circuitry) 979, a camera module 980, a power management module 988, a battery 989, a communication module (e.g., including communication circuitry) 990, a subscriber identification module 996, an antenna module 997, and a connecting terminal 978. According to an embodiment, the electronic device 901 may not include at least one (e.g., the display device 960 or the camera module 980) of the above-described elements or may further include other element(s).

A bus (not shown) may interconnect the above-described elements 920 to 990 and may include a circuit for conveying signals (e.g., a control message or data) between the above-described elements. The processor 920 may include various processing circuitry, such as, for example, and without limitation, one or more of a dedicated processor, a central processing unit (CPU), an application processor (AP), a graphic processing unit (GPU), an image signal processor (ISP) of a camera or a communication processor (CP). According to an embodiment, the processor 920 may be implemented with a system on chip (SoC) or a system in package (SiP). For example, the processor 920 may drive an operating system (OS) or an application to control at least one of another element (e.g., hardware or software element) connected to the processor 920 and may process and compute various data. The processor 920 may load a command or data, which is received from at least one of other elements (e.g., the communication module 990), into a volatile memory 932 to process the command or data and may store the result data into a nonvolatile memory 934. According to an embodiment, the processor 920 may include a main processor 921 and an auxiliary processor 923.

The memory 930 may include, for example, the volatile memory 932 and/or the nonvolatile memory 934. The volatile memory 932 may include, for example, a random access memory (RAM) (e.g., a dynamic RAM (DRAM), a static RAM (SRAM), or a synchronous DRAM (SDRAM)). The nonvolatile memory 934 may include, for example, an one time programmable read-only memory (OTPROM), a programmable read-only memory (PROM), an erasable PROM (EPROM), an electrically EPROM (EEPROM), a mask ROM, a flash ROM, a flash memory, a hard disk drive (HDD), or a solid-state drive (SSD). In addition, the nonvolatile memory 934 may be configured in the form of an internal memory 936 or the form of an external memory 938 which is available through connection only if necessary, according to the connection with the electronic device 901. The external memory 938 may further include a flash drive such as compact flash (CF), secure digital (SD), micro secure digital (Micro-SD), mini secure digital (Mini-SD), extreme digital (xD), a multimedia card (MMC), or a memory stick. The external memory 938 may be operatively or physically connected with the electronic device 901 in a wired manner (e.g., a cable or a universal serial bus (USB)) or a wireless (e.g., Bluetooth) manner.

For example, the memory 930 may store, for example, at least one different software element, such as a command or data associated with the program 940, of the electronic device 901. The program 940 may include, for example, and without limitation, an operating system 942, a middleware 944, an application 946 and/or an application program (interchangeably, “application”) 947, or the like.

The input device 950 may include various input circuitry, such as, for example, and without limitation, a microphone, a mouse, and/or a keyboard, or the like. According to an embodiment, the keyboard may include a keyboard physically connected or a virtual keyboard displayed through the display 960.

The display 960 may include a display, a hologram device or a projector, and a control circuit to control a relevant device. The display may include various types of display, such as, for example, and without limitation, a liquid crystal display (LCD), a light emitting diode (LED) display, an organic LED (OLED) display, a microelectromechanical systems (MEMS) display, and/or an electronic paper display, or the like. According to an embodiment, the display may be flexibly, transparently, or wearably implemented. The display may include a touch circuitry, which is able to detect a user's input such as a gesture input, a proximity input, or a hovering input or a pressure sensor (interchangeably, a force sensor) which is able to measure the intensity of the pressure by the touch. The touch circuit or the pressure sensor may be implemented integrally with the display or may be implemented with at least one sensor separately from the display. The hologram device may show a stereoscopic image in a space using interference of light. The projector may project light onto a screen to display an image. The screen may be located inside or outside the electronic device 901.

The audio module 970 may include various audio circuitry and convert, for example, from a sound into an electrical signal or from an electrical signal into the sound. According to an embodiment, the audio module 970 may acquire sound through the input device 950 (e.g., a microphone) or may output sound through an output device (not illustrated) (e.g., a speaker or a receiver) included in the electronic device 901, an external electronic device (e.g., the electronic device 902 (e.g., a wireless speaker or a wireless headphone)) or an electronic device 906 (e.g., a wired speaker or a wired headphone) connected with the electronic device 901

The sensor module 976 may measure or detect, for example, an internal operating state (e.g., power or temperature) of the electronic device 901 or an external environment state (e.g., an altitude, a humidity, or brightness) to generate an electrical signal or a data value corresponding to the information of the measured state or the detected state. The sensor module 976 may include, for example, and without limitation, at least one of a gesture sensor, a gyro sensor, a barometric pressure sensor, a magnetic sensor, an acceleration sensor, a grip sensor, a proximity sensor, a color sensor (e.g., a red, green, blue (RGB) sensor), an infrared sensor, a biometric sensor (e.g., an iris sensor, a fingerprint sensor, a heartbeat rate monitoring (HRM) sensor, an e-nose sensor, an electromyography (EMG) sensor, an electroencephalogram (EEG) sensor, an electrocardiogram (ECG) sensor), a temperature sensor, a humidity sensor, an illuminance sensor, and/or an UV sensor, or the like. The sensor module 976 may further include a control circuit for controlling at least one or more sensors included therein. According to an embodiment, the sensor module 976 may be controlled by using the processor 920 or a processor (e.g., a sensor hub) separate from the processor 920. In the case that the separate processor (e.g., a sensor hub) is used, while the processor 920 is in a sleep state, the separate processor may operate without awakening the processor 920 to control at least a portion of the operation or the state of the sensor module 976.

According to an embodiment, the interface 977 may include various interface circuitry, such as, for example, and without limitation, a high definition multimedia interface (HDMI), a universal serial bus (USB), an optical interface, a recommended standard 232 (RS-232), a D-subminiature (D-sub), a mobile high-definition link (MHL) interface, a SD card/MMC(multi-media card) interface, and/or an audio interface, or the like. A connecting terminal 978 may physically connect the electronic device 901 and the electronic device 906. According to an embodiment, the connecting terminal 978 may include, for example, an USB connector, an SD card/MMC connector, or an audio connector (e.g., a headphone connector).

The haptic module 979 may include various haptic circuitry and convert an electrical signal into mechanical stimulation (e.g., vibration or motion) or into electrical stimulation. For example, the haptic module 979 may apply tactile or kinesthetic stimulation to a user. The haptic module 979 may include various haptic circuitry, such as, for example, and without limitation, a motor, a piezoelectric element, and/or an electric stimulator, or the like.

The camera module 980 may capture, for example, a still image and a moving picture. According to an embodiment, the camera module 980 may include at least one lens (e.g., a wide-angle lens and a telephoto lens, or a front lens and a rear lens), an image sensor, an image signal processor, or a flash (e.g., a light emitting diode or a xenon lamp).

The power management module 988, which is to manage the power of the electronic device 901, may constitute at least a portion of a power management integrated circuit (PMIC).

The battery 989 may include a primary cell, a secondary cell, or a fuel cell and may be recharged by an external power source to supply power at least one element of the electronic device 901.

The communication module 990 may include various communication circuitry and establish a communication channel between the electronic device 901 and an external device (e.g., the first external electronic device 902, the second external electronic device 904, or the server 908). The communication module 990 may support wired communication or wireless communication through the established communication channel. According to an embodiment, the communication module 990 may include a wireless communication module 992 or a wired communication module 994. The communication module 990 may communicate with the external device (e.g., the first external electronic device 902, the second external electronic device 904, or the server 908) through a first network 998 (e.g. a wireless local area network such as Bluetooth or infrared data association (IrDA)) or a second network 999 (e.g., a wireless wide area network such as a cellular network) through a relevant module among the wireless communication module 992 or the wired communication module 994.

The wireless communication module 992 may support, for example, cellular communication, local wireless communication, global navigation satellite system (GNSS) communication. The cellular communication may include, for example, long-term evolution (LTE), LTE Advance (LTE-A), code division multiple access (CMA), wideband CDMA (WCDMA), universal mobile telecommunications system (UMTS), wireless broadband (WiBro), or global system for mobile communications (GSM). The local wireless communication may include wireless fidelity (Wi-Fi), WiFi Direct, light fidelity (Li-Fi), Bluetooth, Bluetooth low energy (BLE), Zigbee, near field communication (NFC), magnetic secure transmission (MST), radio frequency (RF), or a body area network (BAN). The GNSS may include at least one of a global positioning system (GPS), a global navigation satellite system (Glonass), Beidou Navigation Satellite System (Beidou), the European global satellite-based navigation system (Galileo), or the like. In the present disclosure, “GPS” and “GNSS” may be interchangeably used.

According to an embodiment, when the wireless communication module 992 supports cellar communication, the wireless communication module 992 may, for example, identify or authenticate the electronic device 901 within a communication network using the subscriber identification module (e.g., a SIM card) 996. According to an embodiment, the wireless communication module 992 may include a communication processor (CP) separate from the processor 920 (e.g., an application processor (AP)). In this case, the communication processor may perform at least a portion of functions associated with at least one of elements 910 to 996 of the electronic device 901 or substitute for the processor 920 when the processor 920 is in an inactive (sleep) state, and together with the processor 920 when the processor 920 is in an active state. According to an embodiment, the wireless communication module 992 may include a plurality of communication modules, each supporting only a relevant communication scheme among cellular communication, local wireless communication, or a GNSS communication.

The wired communication module 994 may include, for example, include a local area network (LAN) service, a power line communication, or a plain old telephone service (POTS).

For example, the first network 998 may employ, for example, WiFi direct or Bluetooth for transmitting or receiving commands or data through wireless direct connection between the electronic device 901 and the first external electronic device 902. The second network 999 may include a telecommunication network (e.g., a computer network such as a LAN or a WAN, the Internet or a telephone network) for transmitting or receiving commands or data between the electronic device 901 and the second electronic device 904.

According to various embodiments, the commands or the data may be transmitted or received between the electronic device 901 and the second external electronic device 904 through the server 908 connected with the second network 999. Each of the first and second external electronic devices 902 and 904 may be a device of which the type is different from or the same as that of the electronic device 901. According to various embodiments, all or a part of operations that the electronic device 901 will perform may be executed by another or a plurality of electronic devices (e.g., the electronic devices 902 and 904 or the server 908). According to an embodiment, in the case that the electronic device 901 executes any function or service automatically or in response to a request, the electronic device 901 may not perform the function or the service internally, but may alternatively or additionally transmit requests for at least a part of a function associated with the electronic device 901 to any other device (e.g., the electronic device 902 or 904 or the server 908). The other electronic device (e.g., the electronic device 902 or 904 or the server 908) may execute the requested function or additional function and may transmit the execution result to the electronic device 901. The electronic device 901 may provide the requested function or service using the received result or may additionally process the received result to provide the requested function or service. To this end, for example, cloud computing, distributed computing, or client-server computing may be used.

According to various embodiments, an electronic device includes a display panel including at least one pixel area in which a plurality of pixels configured to radiate light outside the electronic device are arranged and at least one light-transmitting area through which at least a portion of light reflected by an object outside passes, and an image sensor disposed below at least a partial area of the display panel, wherein the image sensor includes a lens unit including a first lens configured to modify a path of a portion of the reflected light and a second lens configured to modify a path of another portion of the reflected light, an optical sensor including a first light-receiving sensor configured to obtain the portion of the reflected light having passed through the lens unit and a second light-receiving sensor configured to obtain the other portion of the reflected light, and at least one light-shielding member between the first light-receiving sensor and the second light-receiving sensor, the light-shielding member being configured to block interference between the portion of the reflected light obtained using the first light-receiving sensor and the other portion of the reflected light obtained using the second light-receiving sensor.

According to various embodiments, the first lens and/or the second lens includes a lens surface on which the reflected light is incident and a plurality of side surfaces for the lens surface, and at least some of the plurality of side surfaces surround at least four vertices where the at least some of the plurality of side surfaces meet.

According to various embodiments, a portion of the light-shielding member is disposed in at least a partial area where the portion of the reflected light and the other portion of the reflected light cross each other.

According to various embodiments, a hole is formed in the portion of the light-shielding member, and one of the first and second light-receiving sensors has a larger diameter than the hole.

According to various embodiments, the light-shielding member includes one or more holes, and at least one of the holes is disposed to correspond to two or more of a plurality of light-receiving sensors included in the optical sensor.

According to various embodiments, the electronic device further includes a filter layer configured to block at least some wavelengths of the light or the reflected light. The filter layer is disposed between the display panel and the lens unit. The filter layer is formed on a lens surface of the lens unit.

According to various embodiments, the lens unit has a pitch of 100 μm or less.

According to various embodiments, the display panel causes some of the plurality of pixels to output light and restricts other pixels from outputting light when the electronic device operates to recognize the object.

According to various embodiments, the display panel causes the pixels outputting the light, from among the plurality of pixels, to output light in at least one of a green wavelength band and a blue wavelength band when the electronic device operates to recognize the object. The display panel causes the pixels outputting the light, among the plurality of pixels, to output light in a blue wavelength band.

According to various embodiments, the electronic device further includes a lighting layer disposed above the display panel and configured to radiate light outside the electronic device. The image sensor collects recognition information about the object using light reflected by the object after radiated from the lighting layer.

According to various embodiments, an electronic device includes a display panel configured to output light to the outside, a sensor module disposed below the display panel and configured to generate an electrical signal using light reflected by an external object based on light output from a plurality of pixels included in the display panel, and a processor configured to recognize the external object, based on the electrical signal, wherein the sensor module includes a micro lens layer including a plurality of lenses and is configured to modify a path of the reflected light, a light-shielding layer configured to pass a portion of the reflected light and to block another portion of the reflected light, and an optical sensor layer configured to convert the reflected light having passed through the light-shielding layer into the electrical signal.

According to various embodiments, the electronic device further includes a protection layer and/or a heat dissipation layer disposed on a rear surface of the display panel, wherein the protection layer and/or the heat dissipation layer includes an opening and/or a hole in at least a portion of the protection layer and/or the heat dissipation layer, and wherein the sensor module is disposed in the opening and/or the hole.

According to various embodiments, the light-shielding layer includes a plurality of holes configured to guide the reflected light toward a light-receiving sensor in the optical sensor layer, and each of the plurality of holes collects light refracted by a lens disposed within a specified range above the hole, from among the plurality of lenses.

According to various embodiments, the micro lens layer has a larger thickness than the light-shielding layer.

According to various embodiments, the processor is configured to output light in at least one of a green wavelength band and a blue wavelength band through some of the plurality of pixels.

According to various embodiments, the processor is configured to output light through some of the plurality of pixels included in an area that is larger than an area corresponding to the sensor module.

According to various embodiments, the processor is configured to output light through the plurality of pixels when an application executed in the electronic device makes a request to recognize the external object or when a user input for recognizing the external object occurs.

According to various embodiments, each of the plurality of holes collects light refracted by first to ninth lenses disposed above the hole.

While the present disclosure has been illustrated and described with reference to various example embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a display panel including at least one pixel area in which a plurality of pixels configured to radiate light outside the electronic device are arranged, and at least one light-transmitting area through which at least a portion of light reflected by an object outside the electronic device passes; and
an image sensor disposed below at least a partial area of the display panel,
wherein the image sensor includes:
a lens unit comprising a first lens configured to modify a path of a portion of the reflected light and a second lens configured to modify a path of another portion of the reflected light;
an optical sensor comprising a first light-receiving sensor configured to receive the portion of the reflected light and a second light-receiving sensor configured to receive the other portion of the reflected light; and
at least one light-shielding member comprising a light shield disposed between the first light-receiving sensor and the second light-receiving sensor, the light-shielding member being configured to block interference between the portion of the reflected light received using the first light-receiving sensor and the other portion of the reflected light received using the second light-receiving sensor.

2. The electronic device of claim 1, wherein the first lens and/or the second lens includes a lens surface on which the reflected light is incident and a plurality of side surfaces, and
wherein at least some of the plurality of side surfaces surround at least four vertices where the at least some of the plurality of side surfaces meet.

3. The electronic device of claim 1, wherein a portion of the light-shielding member is disposed in at least a partial area where the portion of the reflected light and the other portion of the reflected light cross each other.

4. The electronic device of claim 3, wherein a hole is formed in the portion of the light-shielding member, and
wherein at least one of the first and second light-receiving sensors has a diameter greater than a diameter of the hole.

5. The electronic device of claim 1, wherein the light-shielding member includes one or more holes, and
wherein at least one of the holes is disposed to correspond to two or more of a plurality of light-receiving sensors included in the optical sensor.

6. The electronic device of claim 1, further comprising:
a filter layer configured to block at least some wavelengths of the light and/or the reflected light.

7. The electronic device of claim 6, wherein the filter layer is disposed between the display panel and the lens unit.

8. The electronic device of claim 6, wherein the filter layer is disposed on a lens surface of the lens unit.

9. The electronic device of claim 1, wherein the lens unit has a pitch of 100 μm or less.

10. The electronic device of claim 1, wherein the display panel is configured to cause some of the plurality of pixels to output light and to restrict other pixels from outputting light when the electronic device operates to recognize the object.

11. The electronic device of claim 10, wherein the display panel is configured to cause the pixels outputting the light, from among the plurality of pixels, to output light in at least one of a green wavelength band and a blue wavelength band when the electronic device operates to recognize the object.

12. The electronic device of claim 10, wherein the display panel is configured to cause the pixels outputting the light, from among the plurality of pixels, to output light in a blue wavelength band.

13. The electronic device of claim 1, further comprising:
a lighting layer disposed above the display panel and configured to radiate light outside the electronic device.

14. The electronic device of claim 13, wherein the image sensor is configured to collect recognition information about the object using light reflected by the object after being radiated with light from the lighting layer.

15. An electronic device comprising:
a display panel configured to output light to the outside;
a sensor module disposed below the display panel and configured to generate an electrical signal using light reflected by an external object based on light output from a plurality of pixels included in the display panel; and
a processor configured to recognize the external object based on the electrical signal,
wherein the sensor module comprises:
a micro lens layer including a plurality of lenses and configured to modify a path of the reflected light;
a light-shielding layer configured to pass a portion of the reflected light and to block another portion of the reflected light; and
an optical sensor layer configured to convert the portion of the reflected light having passed through the light-shielding layer into the electrical signal.

16. The electronic device of claim 15, further comprising:
a protection layer and/or a heat dissipation layer disposed on a rear surface of the display panel,
wherein the protection layer and/or the heat dissipation layer includes an opening and/or a hole in at least a portion of the protection layer and/or the heat dissipation layer, and
wherein the sensor module is disposed in the opening and/or the hole.

17. The electronic device of claim 15, wherein the light-shielding layer includes a plurality of holes configured to guide the reflected light toward a light-receiving sensor in the optical sensor layer, and
wherein each of the plurality of holes is configured to receive light refracted by a lens disposed within a specified range above the hole from among the plurality of lenses.

18. The electronic device of claim 15, wherein the micro lens layer has a thickness larger than a thickness of the light-shielding layer.

19. The electronic device of claim 15, wherein the processor is configured to output light in at least one of a green wavelength band and a blue wavelength band through some of the plurality of pixels.

20. The electronic device of claim 15, wherein the processor is configured to output light through some of the plurality of pixels included in an area that is larger than an area corresponding to the sensor module.
